(19) United States
(12) Patent Application Publication
(10) Pub. No.: US 2026/0071998 A1
(43) Pub. Date: Mar. 12, 2026

(54) SURFACE ACOUSTIC WAVE SENSOR FORMED WITHIN AN INTEGRATED CIRCUIT ASSEMBLY

(71) Applicant: INTERNATIONAL BUSINESS MACHINES CORPORATION, ARMONK, NY (US)

(72) Inventors: Kishan Jayanand, COHOES, NY (US); Nicholas Alexander POLOMOFF, Hopewell Junction, NY (US); Sarah Nahar Chowdhury, Guilderland, NY (US); Ashim Dutta, Clifton Park, NY (US); Chih-Chao Yang, Glenmont, NY (US)

(21) Appl. No.: 18/828,939

(22) Filed: Sep. 9, 2024

(51) Int. Cl. G01N 29/04; G01N 29/24

(52) U.S. Cl. CPC G01N 29/041; G01N 29/2437; G01N 2291/0231; G01N 2291/0289

(57) ABSTRACT

Provided are an assembly and method to form an integrated circuit assembly including a first die having a first sensor portion coupled to first metal connections on the first die. A second die has a second die sensor portion coupled to second metal connections on the second bottom die. A bond interface electromechanically couples the first metal connections and the second metal connections to couple the first and the second sensor portions. The first and the second sensor portions when electromechanically coupled through the bond interface operate together to produce signals used to determine conditions of the bond interface.

### BACKGROUND OF THE INVENTION

### 1. Field of the Invention

Provided are an assembly and method to form an assembly for a surface acoustic wave sensor formed within an integrated circuit assembly.

### 2. Description of the Related Art

Hybrid bonding is used to vertically stack dies or chips that are bumpless so that the top die and the bottom die are flush against each other to provide for more compact packaging. There are no solder and bumps used with hybrid bonding. Instead, both dies have copper pads that are joined together for copper-to-copper connections during the heating of the hybrid bonding joining process. Following the hybrid bonding, cracks and wafer warpage may occur that weaken the hybrid bond interface. Microcracks can propagate through the layers and cause circuit failures.

### SUMMARY

Provided are an assembly and method to form an integrated circuit assembly including a first die having a first sensor portion coupled to first metal connections on the first die. A second die has a second die sensor portion coupled to second metal connections on the second bottom die. A bond interface electromechanically couples the first metal connections and the second metal connections to couple the first and the second sensor portions. The first and the second sensor portions when electromechanically coupled through the bond interface operate together to produce signals used to determine conditions of the bond interface.

Further, provided are an assembly and method to form an integrated circuit assembly comprising a first die and a second die. The first die has first device layers, a first dielectric layer, below the first device layers, having an opening, and a first sensor portion formed in the opening of the first dielectric layer. The second die has second device layers, a second dielectric layer, above the second device layers, having an opening, and a second sensor portion formed in the opening of the second dielectric layer. A bond interface interconnects the second die and the first die. The first sensor portion, the second sensor portion and the bond interface operate together to produce signals used determine conditions of the bond interface.

Further provided is a method for monitoring an integrated circuit structure. An input signal is transmitted through a transmission line in a first die to a second die over a bond interface between the first and the second dies. A first sensor portion in the second die converts the input signal to a mechanical wave. The mechanical wave is transmitted across the bond interface to a second sensor portion in the first die. A second sensor portion in the first die converts the mechanical wave to an output signal. The input signal and the output signal are compared to determine conditions of the bond interface. The determined conditions of the bond interface are outputted.

### BRIEF DESCRIPTION OF THE DRAWINGS

FIG. 1 illustrates an embodiment of an assembly in which a surface acoustic wave (SAW) sensor is formed in a top die, bottom die, and hybrid bond interface between the dies.

FIG. 2 illustrates an embodiment of a hybrid bond interface connecting sensor portions of the SAW sensor in the top and bottom dies.

FIG. 3 illustrates an embodiment of a method for forming a SAW sensor in a top and bottom dies bonded through hybrid bonding.

FIGS. 4-15 illustrate embodiments of the top die and the bottom die during the manufacturing process to form the SAW sensor in the assembly to monitor the hybrid bond interface.

FIG. 16 illustrates an embodiment of operations to use the assembly of FIGS. 1, 2, 4-15 to monitor the hybrid bond interface.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure.

Example 1: An integrated circuit assembly comprising a first die having a first sensor portion coupled to first metal connections on the first die. A second die has a second die sensor portion coupled to second metal connections on the second bottom die. A bond interface electromechanically couples the first metal connections and the second metal connections to couple the first and the second sensor portions. The first and the second sensor portions when electromechanically coupled through the bond interface operate together to produce signals used to determine conditions of the bond interface. Thus, embodiments advantageously provide sensor portions within the two dies that are bonded together to allow sensor portions in the dies to monitor the conditions in the bond interface. Thus detection of conditions in the bond interface is embedded in the dies themselves to operate continuously during operations of the integrated circuit assembly.

Example 2: The limitations of any of Examples 1 and 3-7 may optionally include that the bond interface comprises a hybrid bond interface. Thus, embodiments advantageously allow monitoring of conditions in a hybrid bond interface that couples two dies together with first and second sensors embedded in the dies subject to the bonding.

Example 3: The limitations of any of Examples 1, 2 and 4-7 may optionally include that the conditions determined through the produced signals are a member of a set of conditions consisting of: temperature, strain, crack formation, viscosity, density, mass, pressure, conductivity, and electromigration at the bond interface. Thus, embodiments advantageously allow for monitoring of many conditions, including conditions related to whether stress in the bond interface is resulting in crack formation, to allow reporting of such conditions that could indicate a catastrophic failure in the integrated circuit assembly.

Example 4: The limitations of any of Examples 1-3 and 4-7 may optionally include that the electromechanically coupled first and second sensor portions and the bond interface form a surface acoustic wave sensor. The second sensor portion transmits a mechanical wave across the bond interface to the first sensor portion. Thus, embodiments advantageously have a surface acoustic wave sensor formed in the first and second dies bonded together to allow for monitoring of conditions within the bond interface using the surface acoustic wave sensor.

Example 5: The limitations of any of Examples 1-4 and 6-7 may optionally include that the second sensor portion comprises an input interdigitated electrode transducer with piezoelectric crystals. The first sensor portion comprises an output interdigitated electrode transducer with piezoelectric crystals. The bond interface couples the input interdigitated electrode transducer and the output interdigitated electrode transducer. Thus, embodiments advantageously embed interdigitated electrode transducers with piezoelectric crystals within the first and dies coupled by the bond interface to allow detection of conditions in the bond interface directly in the integrated circuit assembly.

Example 6: The limitations of any of Examples 1-5 and 7 may optionally include an input radio frequency (RF) transmission line embedded in the first die and electrically coupled to the bond interface to transmit input RF signals across the bond interface to the input interdigitated electrode transducer in the second die The input RF signals are received at the input interdigitated electrode transducer and converted to acoustic waves transmitted across the bond interface to the output interdigitated electrode transducer to produce output RF signals. An output RF transmission line embedded in the first die is coupled to the output interdigitated electrode transducer to transmit the output RF signals from the output interdigitated electrode transducer. The input and the output RF signals are compared to determine the conditions of the bond interface. Thus, embodiments advantageously provide a compact implementation with the input and output RF transmission lines embedded in the dies to supply an input RF signal transmitted across the bond interface to produce the output RF signal that is compared to the input RF signal to determine the conditions. The required signals travel through RF transmission lines embedded in the dies.

Example 7: The limitations of any of Examples 1-6 may optionally include that the first die includes circuitry in layers between the first sensor portion and a first surface of the first die opposite a second surface of the first die coupled to the bond interface. The second die includes circuitry in layers between the second sensor portion and a second surface of the second die opposite a first surface of the second die coupled to the bond interface. Thus, embodiments advantageously have layers between the sensor portions in the layers and the surfaces of the die that are coupled to the bond interface in which the connectors are formed to have the sensor portions as close as possible to the bond interface at the surfaces of the die separated by a minimal number of layers needed for the bonding process and the connectors between the bond interface and the first and second sensor portions.

Example 8: An integrated circuit assembly having a first die and a second die. The first die has first device layers, a first dielectric layer, below the first device layers, having an opening; and a first sensor portion formed in the opening of the first dielectric layer. The second die has second device layers, a second dielectric layer, above the second device layers, having an opening, and a second sensor portion formed in the opening of the second dielectric layer. A bond interface interconnects the second die and the first die. The first sensor portion, the second sensor portion and the bond interface operate together to produce signals used determine conditions of the bond interface. Thus, embodiments advantageously provide sensor portions within the two dies that are bonded together to allow sensor portions in the dies to monitor the conditions in the bond interface. Thus detection of conditions in the bond interface is embedded in the dies themselves.

Example 9: The limitations of any of Examples 8 and 10-12 may optionally include that the first die further includes a first BEOL layer below the first dielectric layer having first metal connectors to electrically couple to the first sensor portion and the first device layers. The second die further includes a second BEOL layer above the second dielectric layer having second metal connectors to electrically couple to the second sensor portion and the second device layers. The bond interface connects the first and the second metal connectors to interconnect the second die and the first die. Thus, embodiments advantageously includes the connectors in BEOL layers to couple the sensor portions to the bond interface to have the connectors right below the bonding surface.

Example 10: The limitations of any of Examples 8, 9, 11, and 12 may optionally include that the first sensor portion comprises a first piezoelectric substrate formed in the opening of the first dielectric layer having wiring to connect to the first connectors of the first BEOL layer, wherein the second sensor portion comprises a second piezoelectric substrate formed in the opening of the second dielectric layer having wiring to connect to the second connectors of the second BEOL layer. Thus, embodiments advantageously embed piezoelectric substrates in the layers of the first and second dies to allow converting signals transmitted across the bond interface to mechanical waves to measure the properties of the bond interface and back to output RF signals electrical to compare with the input RF signals to determine conditions of the bond interface.

Example 11: The limitations of any of Examples 8-10 and 12 may optionally include that the bond interface comprises a hybrid bond. The bond interface includes electrical interconnect structures to connect the first device layers and the second device layers. Thus, embodiments advantageously provide for sensors embedded in the dies bonded by a hybrid bond for the purpose of detecting conditions directly in the hybrid bond interface during integrated circuit operations in the field and during manufacture.

Example 12: The limitations of any of Examples 8-11 may optionally include that the first sensor portion comprises a first piezoelectric substrate formed in the opening of the first dielectric layer. The second sensor portion comprises a second piezoelectric substrate formed in the opening of the second dielectric layer. Thus, embodiments advantageously have the piezoelectric substrates formed in openings of layers of the first and second dies to embed the sensors for the bond interface directly in the dies connected by the bond interface.

Example 13 is a method to manufacture and form the integrated circuit assemblies of Examples 1-12.

Example 14 is a method for monitoring an integrated circuit structure by transmitting an input signal through a transmission line in a first die to a second die over a bond interface between the first and the second dies. The method comprises a first sensor portion in the second die that converts the input signal to a mechanical wave. The method further comprises that a mechanical wave is transmitted across a bond interface to a second sensor portion in the first die. The method further comprises the second sensor portion in the first die converts the mechanical wave to an output signal. The method further comprises that the input signal and the output signal are compared to determine conditions of the bond interface and the determined conditions of the bond interface are outputted. Thus, embodiments advantageously use components of two dies coupled by a bond interface to convert an input signal to a mechanical wave to transmit across the bond interface to convert to an output signal to then use to determine conditions of the bond interface during manufacture and normal in-field operations of the integrated circuit assembly of the first and the second dies coupled by the bond interface.

Example 15: The limitations of any of Examples 14 and 16 may optionally include that the first sensor portion, the second sensor portion, and the bond interface form a surface acoustic wave sensor, and wherein the bond interface comprises a hybrid bond interrace. Thus, embodiments advantageously use a surface acoustic wave sensor formed in the layers of the first and second dies of the integrated circuit assembly to detect conditions of the bond interface.

Example 16: The limitations of any of Examples 14 and 15 may optionally include determining whether the conditions of the bond interface indicate the bond interface has a likelihood of failure exceeding a threshold likelihood of failure. The method further comprises outputting an alert indicating the bond interface is likely to fail in response to determining that the bond interface has a likelihood of failure exceeding a threshold likelihood of failure. Thus, embodiments advantageously use the determined conditions from the sensor portions to determine a likelihood of failure at the bond interface and to output an alert upon detecting a sufficiently high likelihood of failure due to degraded conditions in the bond interface, such as cracks and other stresses.

Hybrid bonding is becoming the preferred technique to form a bond between two dies/wafers. Hybrid bonding reduces signal delay and enables smaller, thinner packages with faster memory/processor speeds while consuming less power. During manufacture and post-manufacture, i.e., in-field of use of dies having hybrid bonding, extreme environmental forces can influence failure at the bond interface. One of the problems in the current art is that stresses in the hybrid bond are not detectable and, if they go unnoticed, can result in failures in the package.

Described embodiments provide improvements to a hybrid bond interface by including a monitoring system of the hybrid bond interface that is formed in the dies coupled by the hybrid bond interface. The monitoring system may comprise a surface acoustic wave (SAW) or other sensor portions formed in the top and bottom dies that are connected by the hybrid bond interface. During operations, a radio frequency (RF) signal may be transmitted to an input sensor portion in the bottom die, such as an input interdigitated transducer embedded in a piezoelectric substrate of the top die, that is converted to a mechanical wave that is transmitted across the hybrid bond interface to an output sensor portion in the top die, such as an output interdigitated transducer embedded in a piezoelectric substrate of the top die, that is converted to an output RF signal. The input and output RF signals may then be compared to detect conditions of the hybrid bond interface, such as temperature, strain, crack formation/propagation, and electromigration. These detected conditions may be used for reliability monitoring of the hybrid bond interface and to determine failure modes at the hybrid bond interface, such as defects in the dielectric material at the hybrid bond interface, Cu electromigration, etc.

Certain embodiments relate to electronic assemblies. Embodiments include both devices and methods for forming electronic assemblies.

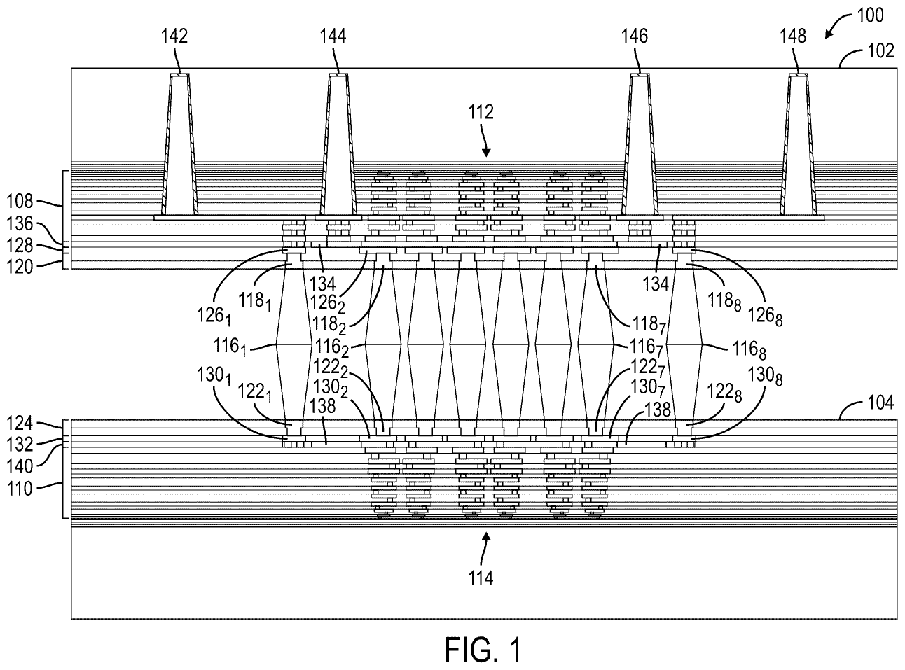

FIG. 1 illustrates an integrated circuit assembly 100 including a surface acoustic wave sensor (SAW) structure formed in a top die 102 and bottom die 104 to monitor a hybrid bond interface 106ᵢ joining the two joined integrated circuit dies 102, 104. The top die 102 and bottom die 104 include device layers 108 and 110 with circuitry and devices 112 and 114, respectively, formed therein to perform functions of the integrated circuit assembly 100, which may include circuitry unrelated to monitoring conditions in the hybrid bond interface 106ᵢ. In certain embodiments, the hybrid bond interface 106ᵢ comprises a hybrid bond interface. The hybrid bond interface 106ᵢ comprises hybrid bond interconnection structures, such as structures 116₁, 116₂ . . . .116₇, 116₈, connecting hybrid bonding pads, such as 118₁, 118₂ . . . 118₇, 118₈, formed in a hybrid bonding dielectric layer 120 on the top die 102 and hybrid bonding pads 122₁, 122₂ . . . 122₇, 122₈ formed in in a hybrid bonding layer 124 on the bottom die 104. The top bonding pads 118₁ . . . .118₈ are coupled to top metal connections, such as 126₁, 126₂ . . . 126₇, 126₈ formed in a top back-end-of-line (BEOL) layer 128. The bottom hybrid bonding pads 122₁, 122₂ . . . 122₇, 122₈ are coupled to bottom metal connections, such as 130₁, 130₂ . . . 130₇, 130₈ formed in a bottom BEOL layer 132.

The metal connections 126₁ in the top die 102 are coupled to an input radio frequency (RF) transmission line 142, e.g., metal traces, through which input RF signals are transmitted, to transmit the input RF signal through the hybrid bound interfaces structure 116₁ to metal connections 130₁ in the bottom die 104 that are coupled to an input interdigitated transducer 138 patterned on a surface of a piezoelectric substrate formed in a dielectric layer 140 of the bottom die 104. Piezoelectric crystals therein convert the input RF signal to a mechanical wave, or surface acoustic waves, that are transmitted across the hybrid bond interface structures 116₂ . . . 116₇ to the output interdigitated transducer 134 patterned on a piezoelectric substrate formed in dielectric layer 136 in the top die 102. The output interdigitated transducer 134 produces electrical signals, i.e., output RF signals, from the mechanical waves through the electrical coupling of the piezoelectric substrate of the piezoelectric substrate sensing the surface waves. The produced output RF signals are transmitted through an output RF transmission line 144. The input and output RF signals may then be compared to determine changes in frequency, amplitude and phase that may be used to determine conditions in the hybrid bond interface 106ᵢ, such as mass, density, viscosity, elastic modulus, conductivity, temperature, and pressure. This information may then be used for reliability monitoring to determine whether there is degradation in the hybrid bond sufficient to warrant recording or alert of an error.

With this structure, a surface wave acoustic (SAW) device structure is formed by the combination of the input interdigitated transducer 138 in a piezoelectric substrate, the output interdigitated transducer 134 in a piezoelectric substrate, and the hybrid bond interface 106ᵢ. In this way, SAW device structure is embedded directly in the integrated circuit assembly 100 to monitor the health and conditions of the hybrid bond interface 106ᵢ.

The top die 102 further includes ground structures 146, 148. The top die 102 further includes devices 112 formed in device layers 108 and the bottom die 104 includes devices 114 formed in device layers 110. The devices 112, 114 may include circuitry and devices to perform functions unrelated to monitoring the hybrid bond interface 106ᵢ specific to the integrated circuit assembly 100.

The terms “top” and “bottom” with respect to the dies and elements within the dies may be replaced by other reference terms for the dies and elements within the dies, such as “first” and “second”, respectively, or other designators.

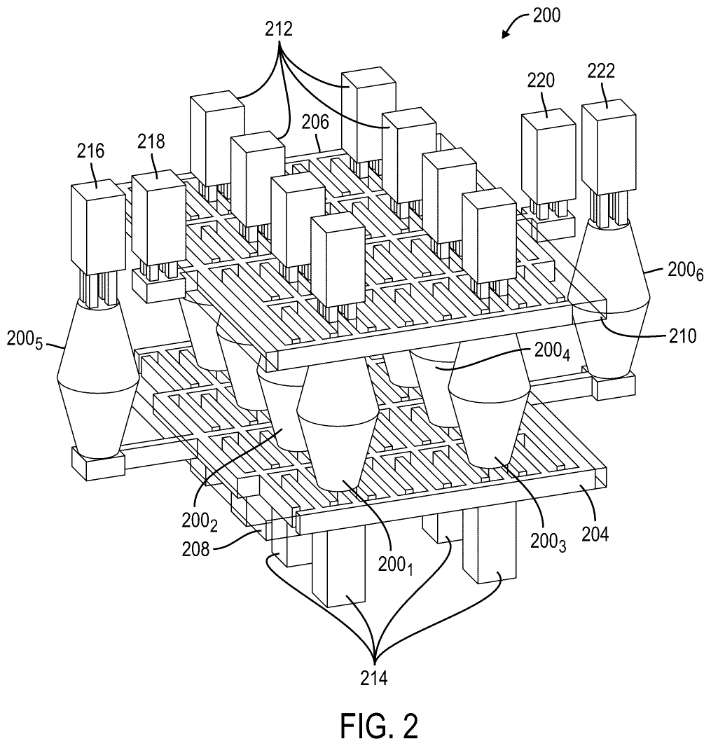

FIG. 2 illustrates an embodiment of a hybrid bond interface 200, such as the hybrid bond interface 106ᵢ of FIG. 1. The hybrid bond interface structures 202₁, 202₂ . . . 202₃, 202₄, 202₅, 202₆ connect input 204 and output 206 interdigitated transducers, such as the input 138 and output 134 interdigitated transducers shown in FIG. 1, formed in the two piezoelectric substrates 208, 210. The hybrid bond interface 200 further includes hybrid bond electrical interconnects 212, 214 to connect to connections below the piezoelectric substrates to connect to device structures 112, 114 in further device layers 108, 110. Hybrid bond electrical interconnects 216, 218 connect to the input 142 and output 144 RF transmission lines and the hybrid bond electronical interconnects 220, 222 that connect to ground structures 146, 148 (FIG. 1). Ground 146, connected to interconnect 220, provides ground for the top die 102 and ground 148, connected to interconnect 222, provides ground for the bottom die 104 through the hybrid bond interface structure 200₆. Hybrid bond interface structure 200₅ couples the input RF signal from the input RF transmission line 142 to the connection 122₁ to provide to the input interdigitated transducer 138 to transfer across the interface bond structures 200₁ . . . 200₄. Thus, the hybrid bond interface 200 couples the input 204 and output 206 interdigitated transducers to allow transmission of the acoustic waves. Further, the hybrid bond interface structures 200₁ . . . 200₄ further couple the device structures 112, 114 (FIG. 1), through the electrical interconnects 212, 214. In this way, the hybrid bond interface 200 connects both the interdigitated transducers 204, 206 forming the SAW structure as well as the device structures 112, 114 in the top die 102 and bottom die 104.

In the described embodiments, a hybrid bond interface is used. In alternative embodiments, different bond interfaces may be used and the SAW sensor formed in the interdigitated transducers 204, 206 may determine conditions of the alternative bond interface.

In described embodiments, the top and bottom portions of the sensor are formed of output 206 and input 204 interdigitated transducers formed in a piezoelectric substrates 208, 210, respectively, to form a SAW sensor. In alternative embodiments, the sensors formed in the top 102 and bottom dies 104 and coupled through the hybrid bond interface may comprise sensors other than SAW sensors, where portions of the alternative sensors are formed in the top and bottom dies.

It should be appreciated that the design and positioning of the elements in relation to the dies and substrates may vary depending on the specific design of the dies, and may take forms different from those illustrated. In addition, as illustrated in certain of the Figures, elements are shown as having certain shapes, surfaces, and relative distances. These configurations, shapes, and distances of elements may be seen in FIGS. 1, 2, and 4-15. The actual shapes of the elements may vary as a result of manufacturing and a variety of shapes are possible, in addition to those illustrated.

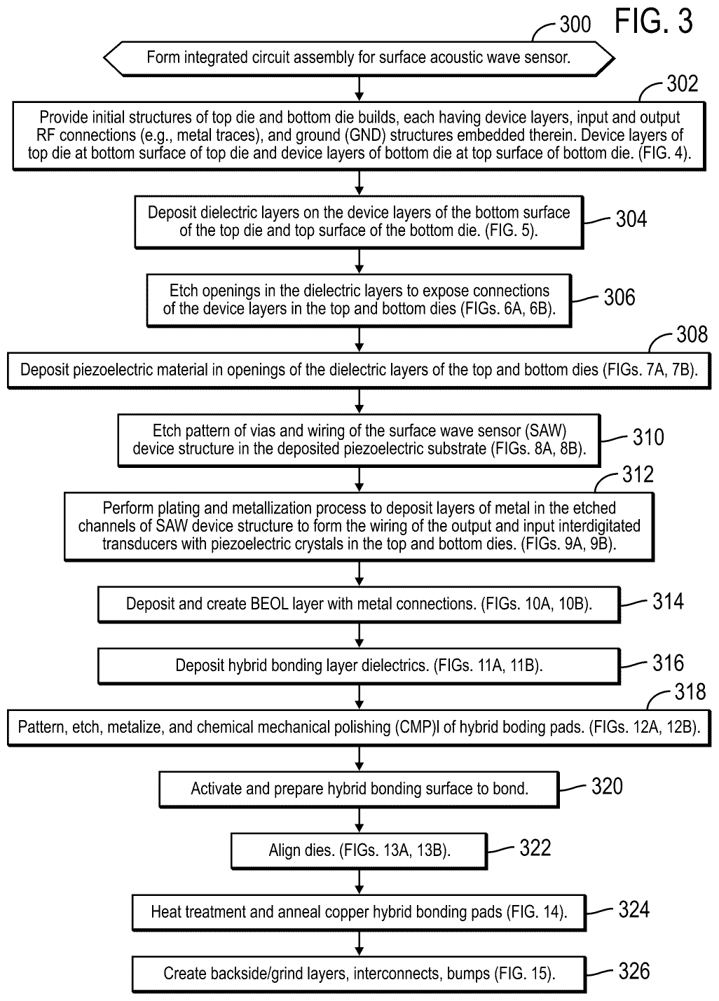

FIG. 3 illustrates an embodiment of a flow of operations to assemble and hybrid bond dies to form a surface acoustic device (SAW) structure in accordance with described embodiments. The operations of FIG. 3 are described with respect to the semiconductor devices described in FIGS. 1, 2-and 4-15. The operations described herein may be performed using semiconductor fabrication systems and machines known in the art comprised of a plurality of stations to perform the processing of the semiconductor devices as described herein.

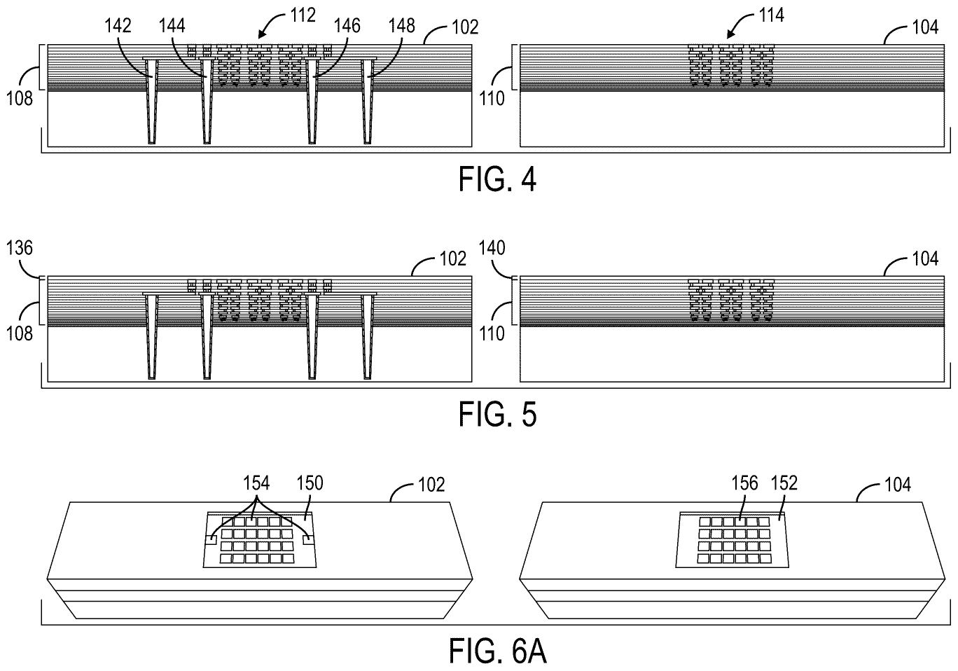

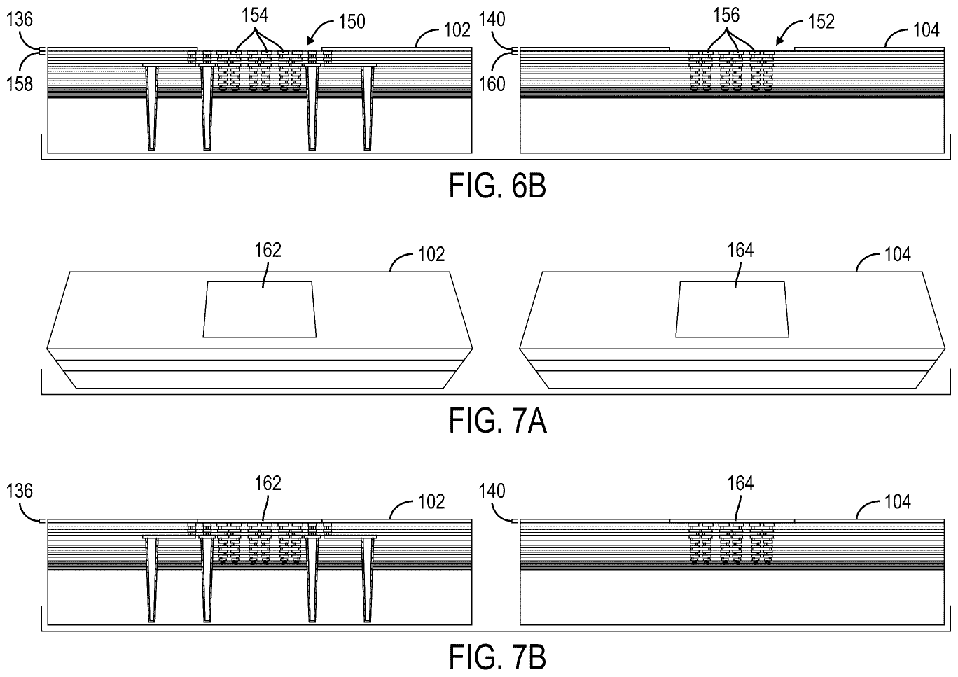

With respect to FIG. 3, upon initiating (at block 300) operations to form the integrated circuit assembly with a SAW sensor, initial structures are provided (at block 302), as shown in FIG. 4, including the top die 102 and the bottom die 104 builds, each having the device layers 108, 110 of device structures 112, 114, input 142 and output 144 RF transmission lines, e.g., metal traces, and ground (GND) structures 146, 148 formed on layers therein. As shown in FIG. 5, dialectic layers 136, 140 are deposited (at block 304) on the top layer of the device layers 108, 110 of the top 102 and bottom 104 dies, respectively. Openings 150, 152 are etched (at block 306) in the dielectric layers 136, 140 to expose connections 154, 156 in the top layers 158, 160 of the device layers 108, 110 in the top 102 and bottom 104 dies, respectively, as shown in FIGS. 6A and 6B. Piezoelectric material is deposited (at block 308) in openings 150, 152 of the dielectric layers 136, 140 of the top 102 and bottom 104 dies to form piezoelectric substrates 162, 164, as shown in FIGS. 7A and 7B.

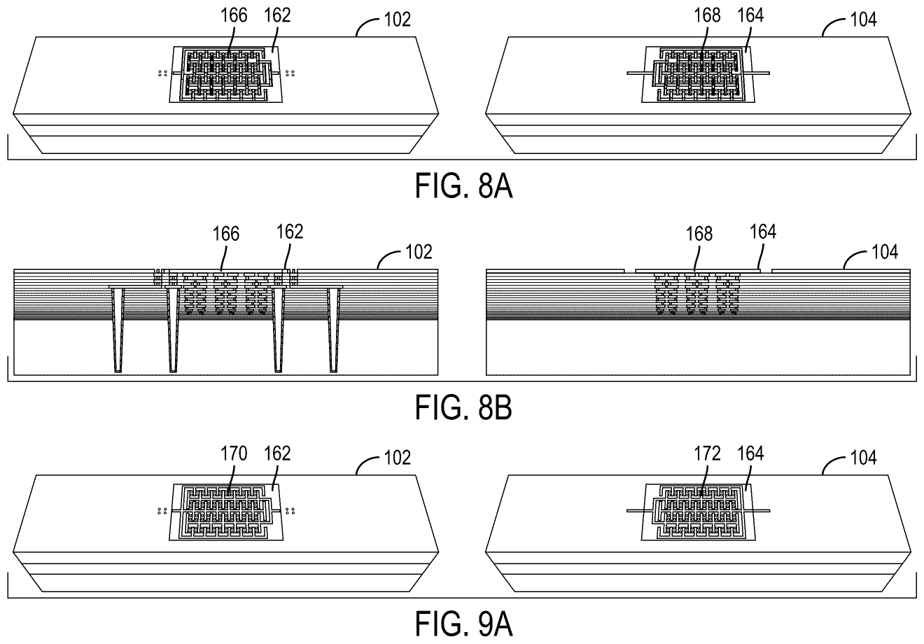

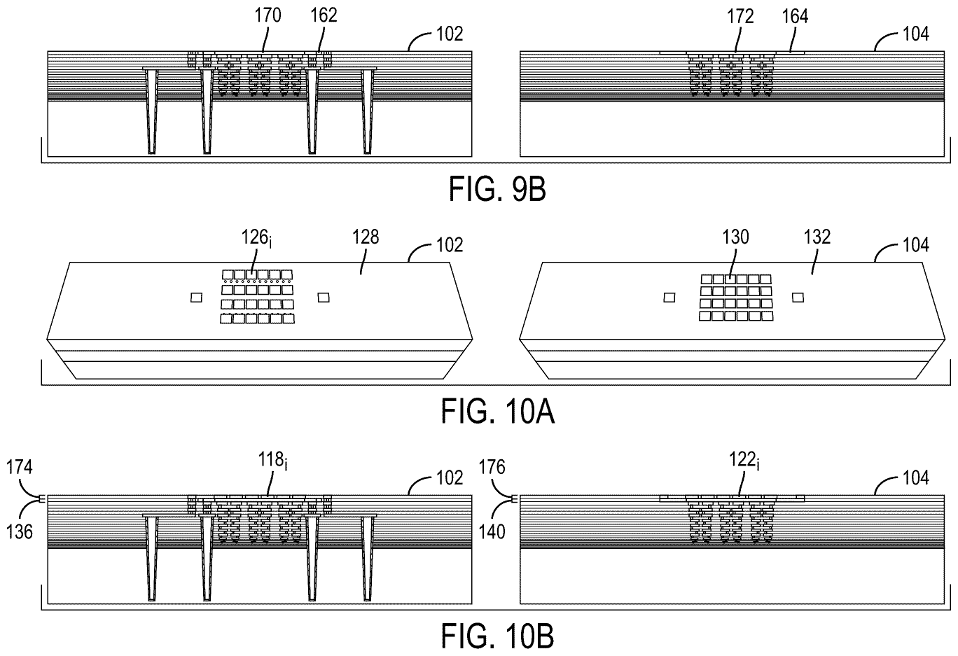

Patterns of vias and wirings of a SAW device structure 166, 168 are etched (at block 310) into the deposited piezoelectric substrates 162, 164, as shown with respect to FIGS. 8A and 8B, to form the channels 166, 168 for output 134 and input 138 interdigitated transducers in the top 102 and bottom 104 dies, respectively. The metal wiring 170, 172 in the etched channels 166, 168 of the SAW device structure is formed by an electro plating and metallization process to deposit (at block 312) a layer of metal into the etched channels 166, 168 of the piezoelectric 162, 164 substrates, as shown in FIGS. 9A, 9B, to form the wiring 170, 172 of the output 134 and input 138 interdigitated transducers with piezoelectric crystals in the top 102 and bottom 104 dies, respectively. BEOL layers 128, 132, as shown in FIGS. 10A and 10B, are deposited (at block 314) onto the dielectric layers 136, 140, in which the piezoelectric substrates 162, 164 and output 134 and input 138 interdigitated transducers are formed. Further, metal connections 126ᵢ, 130ᵢ, also shown in FIG. 1, are formed on the BEOL layers 128, 132 to connect to the output 134 and input 138 interdigitated transducers and the connections 154, 156 to the device structures 112, 114, below.

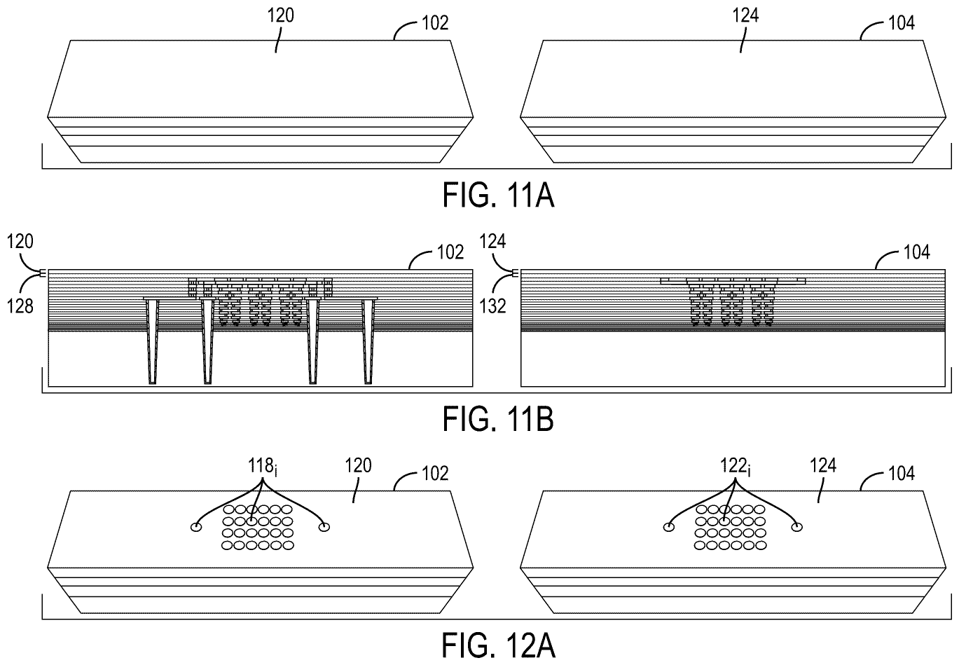

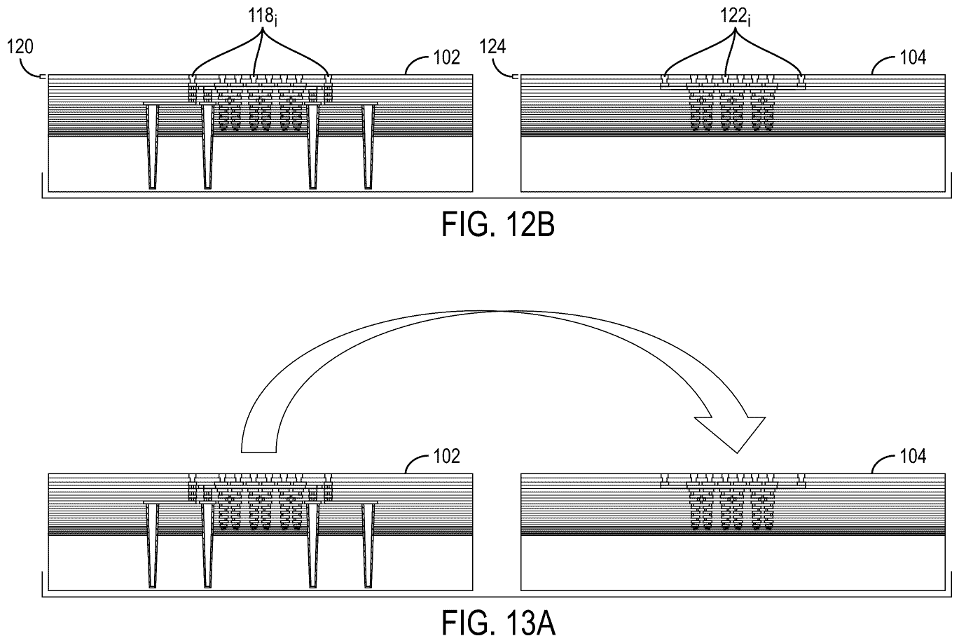

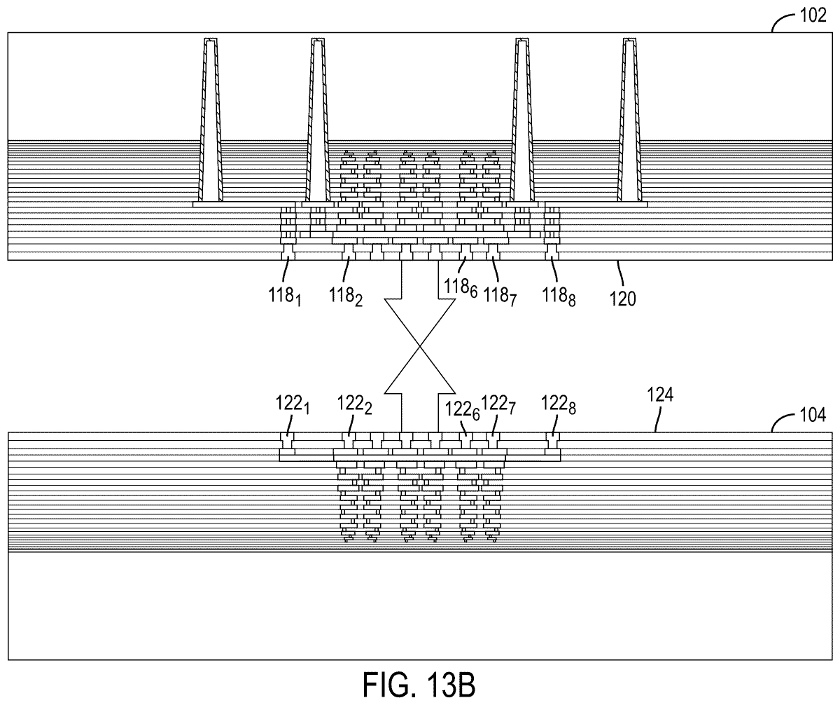

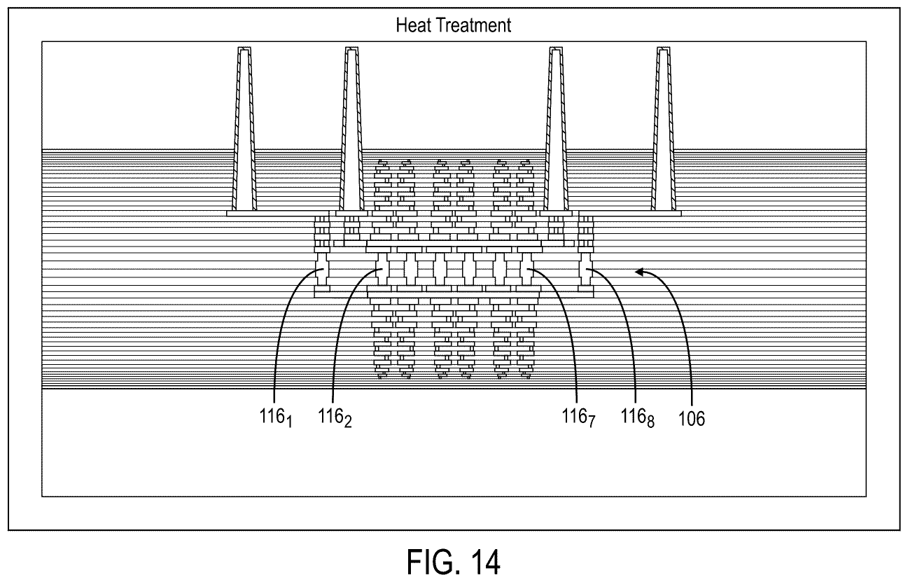

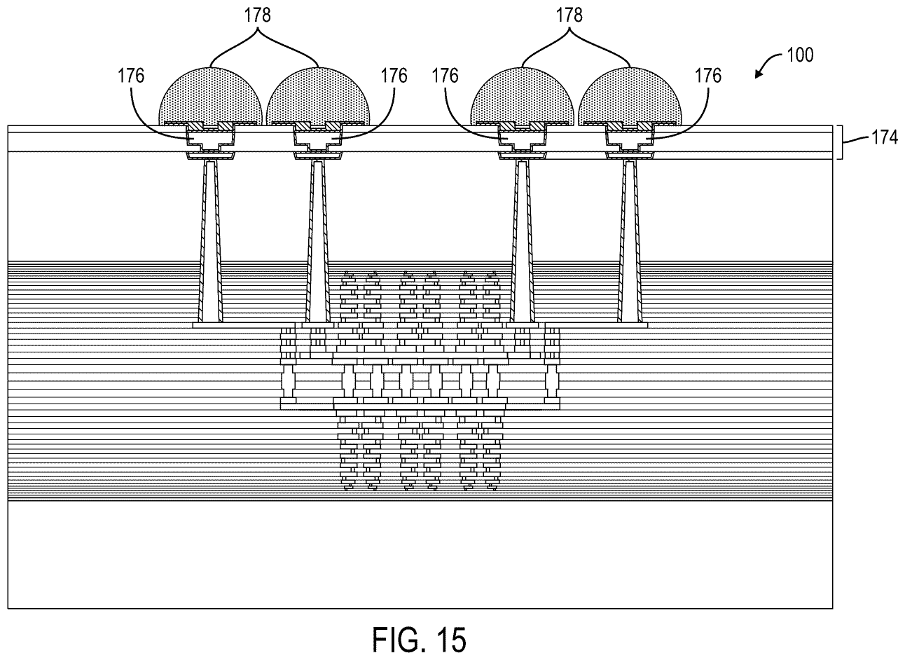

The dielectric layers 120, 124, used for the hybrid bonding, as shown in FIGS. 1, 11A, and 11B, are deposited (at block 316) onto the BEOL layers 128, 132 of the dies 102, 104, respectively, as shown with respect to FIGS. 11A and 11B. Hybrid bonding pads 118ᵢ, 122ᵢ, as shown in FIGS. 1, 12A, 12B, are formed (at block 318) on the hybrid bonding dielectric layers 120, 124 in the top 102 and bottom 104 dies, respectively, by forming patterns, etching, metallizing, and chemical mechanical polishing (CMP) the hybrid bonding pads 118ᵢ, 122ᵢ onto the hybrid bonding dielectric layers 120, 124, as shown in FIGS. 12A and 12B. The hybrid bonding dielectric layers 120, 124 may then be activated (at block 320) and prepared to bond. The top 102 and bottom 104 dies may then be aligned (at block 322) as shown in FIGS. 13A and 13B, where the arrows represent how the dies 102, 104 are stacked to face each other in preparation for joining via hybrid bonding, where the hybrid bonding pads 118ᵢ, 122ᵢ are aligned so as to form the hybrid bond interface structures 116₁, 116₂ . . . . 116₈ therebetween as shown in FIG. 1. Once the dies 102, 104 are aligned as shown in FIG. 13B, a heat treatment and anneal copper process, as shown in FIG. 14, are applied (at block 324) to the hybrid bonding pads 118ᵢ, 122ᵢ to join the hybrid bonding pads to form the hybrid bonding interface 106ᵢ and hybrid bonding interface structures 116₁ . . . .116₈.. Backside/grind layers 174, interconnects 176, and bumps 178 may be created (at block 326) as shown in FIG. 15.

With the described process of FIG. 3 and FIGS. 4-15, a SAW device structure is formed in layers of two separate integrated circuit dies that when joined using hybrid bonding, form a SAW device structure to monitor conditions in the hybrid bond interface.

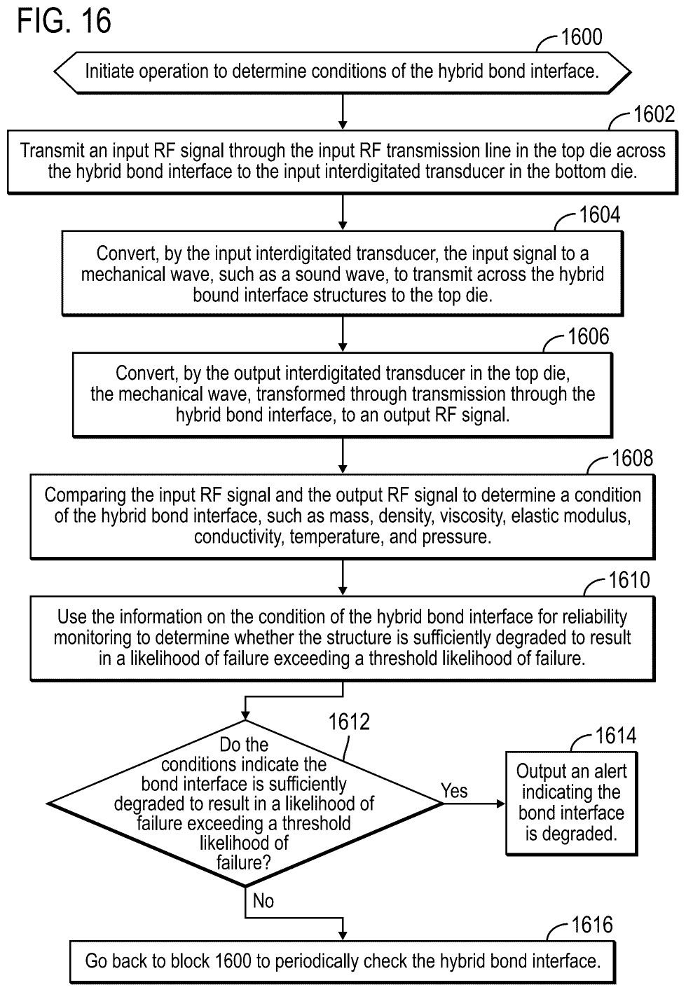

FIG. 16 illustrates an embodiment of operations to use the SAW device structure to determine whether the hybrid bond interface structures 116ᵢ are degraded. Upon initiating (at block 1600) an operation to determine conditions of the hybrid bond interface 116ᵢ, an input RF signal is transmitted (at block 1602) through the input RF transmission line 142 in the top die 102 across the hybrid bond interface structure 116₁ to the input interdigitated transducer 138 in the bottom die 104. The input interdigitated transducer 138 converts (at block 1604) the input RF signal to a mechanical wave, such as a sound wave, to transmit across the hybrid bond interface structures 116₂ . . . 116₇ to the top die 102. The output interdigitated transducer 134 in the top die 102 converts (at block 1606) the mechanical wave, transformed through transmission through the hybrid bond interface, to an output RF signal. A processing component in the devices 112, 114 or in an external device compares (at block 1608) the input RF signal and the output RF signal to determine one or more conditions of the hybrid bond interface, such as mass, density, viscosity, elastic modulus, conductivity, temperature, and pressure. The information on the determined conditions is used (at block 1610) for reliability monitoring to determine whether the structure is sufficiently degraded to result in a likelihood of failure exceeding a threshold likelihood of failure. The likelihood of failure may be determined by applying heuristic rules or a machine learning model to the determined conditions to determine whether the conditions indicate a sufficient level of damage having a likelihood of failure satisfying some failure threshold. If (at block 1612) the conditions indicate the hybrid bond interface is sufficiently degraded to result in a likelihood of failure exceeding a threshold likelihood of failure, e.g., greater than 50%, then an alert may be outputted (at block 1614) indicating the hybrid bond interface 116ᵢ is degraded and likely to result in failure of the integrated circuit assembly. Otherwise, if there is no degradation or the degradation does not indicate a sufficiently high likelihood of failure, from the NO branch of block 1612, then control may proceed back to block 1600 to periodically check the hybrid bond interface for degradation, such as microcracks and stresses.

The integrated circuit assembly 100 may comprise a general purpose microprocessor, central processing unit (CPU), special purpose microprocessor, graphics processing unit (GPU), field programmable gate area (FPGA), Application Specific Integrated Circuit (ASIC), etc.

The method and structure described herein are used in the manufacture of integrated circuits. The resulting integrated circuit chips can be distributed by the fabricator in raw wafer form (i.e., a single wafer with multiple unpackaged chips), bare die, or packaged form. In the latter case, the chip is placed in a single-chip package (e.g., a plastic carrier with leads attached to a motherboard or other higher-level carrier) or in a multi-chip package (e.g., a ceramic carrier with surface interconnects and/or or buried connections). In either case, the chip is then integrated with other chips, discrete circuit elements, and/or other signal processing devices as part of either (a) an intermediate product, such as a motherboard, or (b) an end product. The end product can be any product that contains integrated circuit chips, ranging from toys and other simple applications to advanced computer products with a display, keyboard or other input device, and a central processor.

The terminology used herein is for the purpose of describing particular embodiments only and is not intended to be limiting of the invention. As used herein, the singular forms “a”, “an” and “the” include the plural forms as well, unless the context clearly indicates otherwise. It is further understood that the terms “comprises” and/or “comprising” when used in this specification specify the presence of particular features, integers, steps, operations, elements and/or components, but the presence or addition one or more other features, integers, steps, operations, elements, components and/or groups thereof. “Optional” means that the event or circumstance described below may or may not occur and that the description includes instances where the event occurs and instances where it does not occur.

Approximate formulations, as used in the specification and claims herein, may be used to modify any quantitative representation that is permissible may vary without leading to a change in the basic function to which it relates. Accordingly, a value modified by one or more of the terms “approximately,” “approximately,” and “substantially” is not limited to the precise value specified. In at least some cases, the approximate formulation may correspond to the accuracy of an instrument used to measure the value. Here and throughout the specification and claims, range boundaries may be combined and/or interchanged; such areas are identified and include all sub-areas therein, unless the context or language indicates otherwise. The term “approximately” applied to a specific value of a range refers to both values and, unless otherwise dependent on the accuracy of the meter, can mean +/−10% of the declared value(s).

In discussing the present technology, it may be helpful to describe various salient terms. In one aspect, spatially related terminology such as “front,” “back,” “top,” “bottom,” “beneath,” “below,” “lower,” above,” “upper,” “side,” “left,” “right,” and the like, is used with reference to the direction of the Figures being described. Since components of embodiments of the disclosure can be positioned in a number of different directions, the directional terminology is used for purposes of illustration and is in no way limiting. Thus, it will be understood that the spatially relative terminology is intended to encompass different directions of the device in use or operation in addition to the direction depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other directions) and the spatially relative descriptors used herein should be interpreted accordingly.

As used herein, the terms “coupled” and/or “electrically coupled” are not meant to mean that the elements must be directly coupled together—intervening elements may be provided between the “coupled” or “electrically coupled” elements. In contrast, if an element is referred to as being “directly connected” or “directly coupled” to another element, there are no intervening elements present. The term “electrically connected” refers to a low-ohmic electric connection between the elements electrically connected together.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used and structural or logical changes may be made without departing from the spirit and scope defined by the claims. The description of the embodiments is not limiting.

The description of the present disclosure has been presented for purposes of illustration and description, but is not intended to be exhaustive or limited to the disclosure in the form disclosed. Many modifications and variations will be apparent to those of ordinary skill in the art, and structure or logical changes may be made without departing from the scope and spirit of the disclosure. In particular, elements of the embodiments described hereinafter may be combined with elements of different embodiments. The embodiment was chosen and described in order to best explain the principles of the disclosure and the practical application, and to enable others of ordinary skill in the art to understand the disclosure for various embodiments with various modifications as are suited to the particular use contemplated

What is claimed is:

1. An integrated circuit assembly comprising:
a first die having a first sensor portion coupled to first metal connections on the first die;
a second die having a second sensor portion coupled to second metal connections on the second die; and
a bond interface electromechanically coupling the first metal connections and the second metal connections to couple the first and the second sensor portions, wherein the first and the second sensor portions when electromechanically coupled through the bond interface operate together to produce signals used to determine conditions of the bond interface.

2. The integrated circuit assembly of claim 1, wherein the bond interface comprises a hybrid bond interface.

3. The integrated circuit assembly of claim 1, wherein the conditions determined through the produced signals are a member of a set of conditions consisting of: temperature, strain, crack formation, viscosity, density, mass, pressure, conductivity, and electromigration at the bond interface.

4. The integrated circuit assembly of claim 1, wherein the electromechanically coupled first and second sensor portions and the bond interface form a surface acoustic wave sensor, wherein the second sensor portion transmits a mechanical wave across the bond interface to the first sensor portion.

5. The integrated circuit assembly of claim 4, wherein the second sensor portion comprises an input interdigitated electrode transducer with piezoelectric crystals, wherein the first sensor portion comprises an output interdigitated electrode transducer with piezoelectric crystals, wherein the bond interface couples the input interdigitated electrode transducer and the output interdigitated electrode transducer.

6. The integrated circuit assembly of claim 5, further comprising:
an input radio frequency (RF) transmission line embedded in the first die and electrically coupled to the bond interface to transmit input RF signals across the bond interface to the input interdigitated electrode transducer in the second die, wherein the input RF signals are received at the input interdigitated electrode transducer and converted to acoustic waves transmitted across the bond interface to the output interdigitated electrode transducer to produce output RF signals; and
an output RF transmission line embedded in the first die and coupled to the output interdigitated electrode transducer to transmit the output RF signals from the output interdigitated electrode transducer, wherein the input and the output RF signals are compared to determine the conditions of the bond interface.

7. The integrated circuit assembly of claim 1, wherein the first die includes circuitry in layers between the first sensor portion and a first surface of the first die opposite a second surface of the first die coupled to the bond interface, and wherein the second die includes circuitry in layers between the second sensor portion and a second surface of the second die opposite a first surface of the second die coupled to the bond interface.

8. An integrated circuit assembly, comprising:
a first die, comprising:
first device layers;
a first dielectric layer, below the first device layers, having an opening;
a first sensor portion formed in the opening of the first dielectric layer;
a second die, comprising:
second device layers;
a second dielectric layer, above the second device layers, having an opening;
a second sensor portion formed in the opening of the second dielectric layer; and
a bond interface to interconnect the second die and the first die, wherein the first sensor portion, the second sensor portion and the bond interface operate together to produce signals used determine conditions of the bond interface.

9. The integrated circuit assembly of claim 8,
wherein the first die further includes:
a first BEOL layer below the first dielectric layer having first metal connectors to electrically couple to the first sensor portion and the first device layers; and
wherein the second die further includes:
a second BEOL layer above the second dielectric layer having second metal connectors to electrically couple to the second sensor portion and the second device layers,
wherein the bond interface connects the first and the second metal connectors to interconnect the second die and the first die.

10. The integrated circuit assembly of claim 9, wherein the first sensor portion comprises a first piezoelectric substrate formed in the opening of the first dielectric layer having wiring to connect to the first metal connectors of the first BEOL layer, wherein the second sensor portion comprises a second piezoelectric substrate formed in the opening of the second dielectric layer having wiring to connect to the second metal connectors of the second BEOL layer.

11. The integrated circuit assembly of claim 8, wherein the bond interface comprises a hybrid bond, wherein the bond interface includes electrical interconnect structures to connect the first device layers and the second device layers.

12. The integrated circuit assembly of claim 8, wherein the first sensor portion comprises a first piezoelectric substrate formed in the opening of the first dielectric layer, and wherein the second sensor portion comprises a second piezoelectric substrate formed in the opening of the second dielectric layer.

13. A method for forming an integrated circuit assembly comprising:
providing a first die;
forming a first sensor portion embedded in a first layer of the first die;
depositing a second layer over the first layer of the first die with first metal connections electrically coupled to the first sensor portion;
providing a second die;
forming a second sensor portion embedded in a third layer of the second die;
depositing a fourth layer over the third layer, with second metal connections electrically coupled to the second sensor portion;
preparing a first bonding surface of the first die;
preparing a second bonding surface of the second die;
aligning the first die and the second die to have the first and the second bonding surfaces face each other; and
performing a bonding process to form a bond interface to join the first die and the second die to electromechanically interconnect the first die and the second die and the first sensor portion and the second sensor portion, wherein the first and the second sensor portions and the bond interface operate together to produce signals used determine conditions of the bond interface.

14. The method of claim 13, wherein the bond interface comprises a hybrid bond interface.

15. The method of claim 13, wherein the first and the second sensor portions when electromechanically coupled to the bond interface form a surface acoustic wave sensor.

16. The method of claim 13, wherein the forming the first sensor portion comprises depositing a first piezoelectric material in an opening of the first layer of the first die, wherein the first sensor portion comprises an output interdigitated electrode transducer with piezoelectric crystals, wherein the forming the second sensor portion comprises depositing a second piezoelectric material in an opening of the third layer of the second die, wherein the second sensor portion comprises an input interdigitated electrode transducer with piezoelectric crystals, wherein the bond interface electromechanically couples the input interdigitated electrode transducer and the output interdigitated electrode transducer.

17. The method of claim 16, further comprising:
forming an input radio frequency (RF) transmission line in the first die to electrically couple to the bond interface to transmit input RF signals across the bond interface to the input interdigitated electrode transducer in the second die; and
forming an output RF transmission line in the first die and coupled to the output interdigitated electrode transducer to transmit the RF signals from the output interdigitated electrode transducer.

18. A method for forming an integrated circuit assembly, comprising:
forming first device layers in a first die;
forming a first dielectric layer over the first device layers having an opening;
forming a first sensor portion in the opening of the first dielectric layer;
forming second device layers in a second die;
forming a second dielectric layer over the second device layers having an opening;
forming a second sensor portion in the opening of the second dielectric layer; and
forming a bond interface to interconnect the second die and the first die, wherein the first sensor portion, the second sensor portion, and the bond interface operate together to produce signals used determine conditions of the bond interface.

19. The method of claim 18, further comprising:
depositing a first BEOL layer over the first dielectric layer having first metal connectors to electrically couple to the first sensor portion and the first device layers; and
forming a second BEOL layer over the second dielectric layer having second metal connectors to electrically couple to the second sensor portion and the second device layers,
wherein the forming the bond interface comprises forming the bond interface electrically coupled to the first and the second metal connectors of the first and the second BEOL layers, respectively, to interconnect the second die and the first die.

20. The method of claim 19, wherein the bond interface comprises a hybrid bond interface, wherein the forming the bond interface comprises:
depositing a first hybrid bonding layer on the first BEOL layer;
forming first hybrid bonding pads on the first hybrid bonding layer to couple to the first metal connectors on the first BEOL layer;
depositing a second hybrid bonding layer on the second BEOL layer;
forming a second hybrid bonding pads on the second hybrid bonding layer to connect to the second metal connectors on the second BEOL layer; and
aligning the first and the second dies to have the first and the second hybrid bonding layers face each other, wherein the forming the bond interface comprises heating the aligned first and the second dies to form hybrid bonding structures from the first hybrid bonding pads and the second hybrid bonding pads.

21. The method of claim 18, wherein the bond interface comprises a hybrid bond interface, wherein the forming the bond interface comprises:
depositing a first hybrid bonding layer above the first dielectric layer;
forming first hybrid bonding pads on the first hybrid bonding layer to connect to the first sensor portion;
depositing a second hybrid bonding layer above the second dielectric layer;
forming a second hybrid bonding pads on the second hybrid bonding layer to connect to the second sensor portion; and
aligning the first and the second dies to have the first and the second hybrid bonding layers face each other, wherein the forming the bond interface comprises heating the aligned first and the second dies to form hybrid bonding structures from the first hybrid bonding pads and the second hybrid bonding pads.

22. The method of claim 18,
wherein the forming the first sensor portion comprises:
depositing a first piezoelectric material in the opening of the first dielectric layer to form a first piezoelectric substrate;
etching and metallizing wiring of the first sensor portion on the first piezoelectric substrate,
wherein the forming the second sensor portion comprises:
depositing a second piezoelectric material in the opening of the second dielectric layer to form a second piezoelectric substrate; and
etching and metallizing wiring of the second sensor portion on the second piezoelectric substrate.

23. A method for monitoring an integrated circuit structure, comprising:
transmitting an input signal through a transmission line in a first die to a second die over a bond interface between the first and the second dies;
converting, by a first sensor portion in the second die, the input signal to a mechanical wave;
transmitting the mechanical wave across the bond interface to a second sensor portion in the first die;
converting, by a second sensor portion in the first die, the mechanical wave to an output signal;
comparing the input signal and the output signal to determine conditions of the bond interface; and
outputting the determined conditions of the bond interface.

24. The method of claim 23, wherein the first sensor portion, the second sensor portion, and the bond interface form a surface acoustic wave sensor, and wherein the bond interface comprises a hybrid bond interrace.

25. The method of claim 23, further comprising:
determining whether the conditions of the bond interface indicate the bond interface has a likelihood of failure exceeding a threshold likelihood of failure; and
outputting an alert indicating the bond interface is likely to fail in response to determining that the bond interface has a likelihood of failure exceeding a threshold likelihood of failure.
